(19) United States
(12) Patent Application Publication
(10) Pub. No.: US 2016/0377208 A1
(43) Pub. Date: Dec. 29, 2016

(54) Gasket for Threaded Pipe Flange

(71) Applicant: United States Pipe and Foundry Company, LLC, Birmingham, AL (US)

(72) Inventors: William W. HOLMES, IV, Maylene, AL (US); Russell J. HUGGINS, McCalla, AL (US); Cameron A. CORCORAN, Trussville, AL (US)

(21) Appl. No.: 14/747,807

(22) Filed: Jun. 23, 2015

(51) Int. Cl. F16L 23/22; F16L 15/08; F16J 15/10; F16L 49/04; F16J 15/02; F16L 15/04; F16L 23/00

(52) U.S. Cl. CPC F16L 23/22; F16L 15/04; F16L 15/08; F16L 23/006; F16L 49/04; F16J 15/022; F16J 15/102

(57) ABSTRACT

A gasket comprising a central opening having a first diameter; an inner region adjacent to the central opening, the inner region having an approximately constant first axial thickness and a first radial length; an outer region adjacent to the inner region, the outer region having a second axial thickness and a second radial length, the second axial thickness being less than the first axial thickness, and the second radial length being no more than about thrice the first radial length; and wherein the gasket is constructed from an elastomeric material. The gasket may be used in a pipe joint including at least one threaded pipe flange joined to another pipe flange.

### BACKGROUND

A. Field of the Disclosure

The present disclosure relates generally to pipe joints, specifically pipe joints in which one of the pipes terminates in a threaded flange. Such joints as well as methods for use therewith are provided.

B. Background

Flanges allow pipes to be joined to one another using fasteners such as bolts. Because there are always minor gaps between the pipe flanges regardless of how precisely they are manufactured, a gasket is placed between the pipe flanges to ensure a leak-proof seal. In addition to the inevitable imperfections in the shape of the flanges, changes in internal pressure at the joint will cause the joint to spread or bow, which will result in a leak absent a sealing gasket.

Flanges may be attached to pipes by various means. Flanges that are integrally cast with pipe or welded onto pipe are both durable and provide no opportunity for leaks at the interface between the pipe and the flange. However, the industry is increasingly turning to threaded pipe flanges.

Threaded pipe flanges have threads machined into the internal diametral area of the flange body. Matching threads are then machined onto the outside diametral area of the mating pipe barrel. A material, which acts both as a thread lubricant and thread sealant, is applied to the threaded area of the pipe and the flange is then threaded onto the pipe by mechanical means. Due to variations in the machining process, damage due to mishandling, and damage during finished joint installation, with time the interface between the threaded area of the flange and pipe allows leakage through the thread area. The same sources of variance allow the flange/pipe interfaces to be misaligned with each other when two flanges are mated together. Additionally, threaded flanges are not as rigid under internal pipeline thrust loads as are cast or welded flanges. This lowered rigidity allows the flange to rotate causing a lowering of sealing ability in the gasketed area of the joint assembly.

Current gaskets are not capable of providing a good seal when threaded flanges are used. For example, a ring gasket has a thin sealing radius that often fails to surround the leaking flange/pipe interface, either because the ring is not perfectly centered with regard to the flange or because the two flange/pipe interfaces of the two joined pipes are offset from one another. Flat gaskets are unable to provide an adequate seal over the entire area of the flange when under pressure, due to uneven pressure distribution and bowing. Although such gaskets may be adequate when used with very expensive high-precision joint, such as those used in nuclear power plants or aerospace systems, they are not adequate for use with threaded pipe flanges manufactured for lower value uses such as water distribution, sewerage, and natural gas distribution.

Therefore a need in the art exists for a gasket that can adequately seal a joint between two pipe flanges, in which one or both of the pipe flanges are threaded.

### SUMMARY

The problems in the art discussed above have been addressed by a gasket specifically designed to seal a joint between two pipe flanges, in which at least one of the two pipe flanges is a threaded flange. It is to be understood that not all uses and embodiments of the gasket will address all such problems, and nothing claimed should be limited according to its ability to address such problems.

In a first general embodiment, a circular gasket is provided for use in sealing a joint between two pipe flanges, the gasket comprising: a central opening having a first diameter; an inner region adjacent to the central opening, the inner region having an approximately constant first axial thickness and a first radial length; an outer region adjacent to the inner region, the outer region having a second axial thickness and a second radial length, the second axial thickness being less than the first axial thickness, and the second radial length being no more than about thrice the first radial length; and wherein the gasket is constructed from an elastomeric material.

In a second general embodiment, a pipe joint is provided, the joint comprising: a first pipe having a first inner diameter and comprising a first threaded end; and a first threaded pipe flange having a first outer diameter, screwed onto the first threaded end, forming a first flange/pipe interface having a first interfacial diameter; a second flange having a second outer diameter; the circular gasket disclosed above between the first and second pipe flanges, and positioned to contact the inner region of the gasket with the first flange/pipe interface.

The above summary presents a simplified description in order to provide a basic understanding of some aspects of the claimed subject matter. This summary is not an extensive overview. It is not intended to identify key or critical elements or to delineate the scope of the claimed subject matter. Its sole purpose is to present some concepts in a simplified form as a prelude to the more detailed description that is presented later.

### BRIEF DESCRIPTION OF THE DRAWINGS

FIG. 1: A frontal view of an embodiment of the gasket.

FIG. 2: A cross-sectional view of the embodiment of the gasket shown in FIG. 1.

FIG. 3: A cross-sectional view of an embodiment of the pipe joint, including the embodiment of the gasket shown in FIG. 1.

### DETAILED DESCRIPTION

### A. DEFINITIONS

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments.

The terms “about” and “approximately” shall generally mean an acceptable degree of error or variation for the quantity measured given the nature or precision of the measurements. Typical, exemplary degrees of error or variation are within 20 percent (%), preferably within 10%, and more preferably within 5% of a given value or range of values. Alternatively the degree of error may be 4%, 3%, 2%, 1%, 0.5%, and 0.1%. Numerical quantities given herein are approximate unless stated otherwise, meaning that the term “about” or “approximately” can be inferred when not expressly stated.

The terms “first” and “second” are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

With reference to the use of the words “comprise” or “comprises” or “comprising” in the foregoing description and/or in the following claims, unless the context requires otherwise, those words are used on the basis and clear understanding that they are to be interpreted inclusively, rather than exclusively, and that each of those words is to be so interpreted in construing the foregoing description and the following claims.

The term “consisting essentially of” means that, in addition to the recited elements, what is claimed may also contain other elements (steps, structures, ingredients, components, etc.) that do not adversely affect the operability of what is claimed for its intended purpose as stated in this disclosure. Importantly, this term excludes such other elements that adversely affect the operability of what is claimed for its intended purpose as stated in this disclosure, even if such other elements might enhance the operability of what is claimed for some other purpose.

The term “axial” refers to a direction parallel to the flow of fluid through a pipe joint. Put another way, it refers to a direction parallel to the axis of the cylinder formed by one of the pipes. The axial dimensions of the gasket 1000 and the flanges discussed in this disclosure are sometimes referred to as “thickness.”

The term “radial” refers to a direction perpendicular to the axial direction. Put another way, it refers to a direction parallel to a radius of the cylinder formed by one of the pipes. The radial dimensions of the gasket 1000 and the flanges discussed in this disclosure are sometimes referred to as “length.”

### B. GASKET

A circular gasket 1000 is provided for use in sealing a joint 2000 between two pipe flanges, the gasket 1000 comprising: a central opening 1100 having a first diameter (a); an inner region 1200 adjacent to the central opening 1100, the inner region 1200 having an approximately constant first axial thickness (d) and a first radial length (b); an outer region 1300 adjacent to the inner region 1200, the outer region 1300 having a second axial thickness (e) and a second radial length (c), the second axial thickness (e) being less than the first axial thickness (d), and the second radial length (c) being no more than about thrice the first radial length (b); and wherein the gasket 1000 is constructed from an elastomeric material.

The gasket 1000 is designed to contact a wide area of a pipe flange, in order to directly contact an interface between a pipe and a pipe flange when the position of that interface is subject to a high degree of uncertainly due to imprecision in manufacture and other factors. For that reason, the inner region 1200 of the gasket 1000 is approximately constant in its axial thickness (the “first axial thickness”). The existence of marked variations in the axial thickness of the inner region 1200 (e.g., ridges or indentations) would prevent solid contact between the inner region 1200 of the gasket 1000 and the necessarily wide area of the pipe flange. In some embodiments of the gasket 1000 the first axial thickness (d) is constant within about 25%. In further embodiments of the gasket 1000 the first axial thickness (d) is constant within about 20%, 15%, 10%, 5%, 4%, 3%, 2%, 1%, 0.5%, or 0.1%. In a specific embodiment the first axial thickness (d) of the gasket 1000 is constant (i.e., no significant deviation in axial thickness). Gaskets with “flat faces” (either partially or entirely) are known in other applications, and one of ordinary skill in the art can determine the tolerance to variations in axial thickness that is acceptable for a given application.

The need to provide higher compressions in the inner region 1200 of the gasket 1000 than the outer region 1300 of the gasket 1000 dictates that the axial thickness of the inner region 1200 be greater than the axial thickness of the outer region 1300. In some embodiments of the gasket 1000, the first axial thickness (d) is at least twice the second axial thickness (e). In further embodiments of the gasket 1000, the first axial thickness (d) is at least thrice the second axial thickness (e). In a specific embodiment of the gasket 1000, the first axial thickness (d) is about thrice the second axial thickness (e).

The need to contact a broad area of the threaded flange also dictates that the inner region 1200 be relatively long in the radial dimension compared to the outer region 1300. In further embodiments of the gasket 1000, the second radial length (c) (of the outer region 1300) is no more than about twice the first radial length (b) (of the inner region 1200). In still further embodiments of the gasket 1000 the ratio of the second radial length (c) to the first radial length (b) is selected from the group consisting of: 3 or less, 2 or less, one or less, 1-3, 1-2, 2-3, about 2, and about 3. In a specific embodiment of the gasket 1000 the ratio of the second radial length (c) to the first radial length (b) is 3.

Within these parameters various configurations of the gasket 1000 are possible. For example, in a specific embodiment of the gasket 1000 the inner region 1200 is a rectangular toroid (i.e., a toroid that is rectangular in cross-section). Such embodiments provide an inner region 1200 with a very constant axial thickness to provide good contact with the region of the flange where the flange/pipe interface should be. In another specific embodiment, the inner region 1200 is a rectangular toroid, and the outer region 1300 is a rectangular toroid. In this embodiment the outer region 1300 also provides a flat face to contact the flange in the region outside of the expected location of the flange/pipe interface. In such embodiments the inner region 1200 comprises two opposite faces 1210 in the axial direction, and in which the two opposite faces 1210 are substantially flat and parallel to one another.

Some embodiments of the gasket 1000 comprise openings 1310 for fasteners. In some such embodiments of the gasket 1000, the outer region 1300 comprises a plurality of openings 1310 positioned to accommodate a plurality of fasteners 2500. The openings 1310 will in many cases be positioned at a uniform radial distance from the center of the gasket 1000. They may be distributed to match the same pattern of fastener openings 1310 (such as bolt holes) as found in standard flanges.

The gasket 1000 must be elastomeric. The gasket 1000 must be compressible to provide a seal between the flanges. The gasket 1000 may additionally be constructed from an elastomer with low compression set. Low compression set elastomers will re-expand after being compressed. This property is highly advantageous in a gasket for a pipe joint, as the flanges of the joint 2000 will have a tendency to spread away from one another after installation when the pipe is pressurized. If the gasket 1000 is constructed from high compression set elastomer, it will not re-expand to fill the space between the two flanges in such a situation. However, if it is constructed of low-compression set elastomer the gasket 1000 will re-expand when the flanges shift relative to one another to maintain the seal. Some embodiments of the gasket 1000 are constructed of an elastomer with a compression set no greater than about 20% when measured by Active Standard ASTM D395 Method B.

Hardness can also have an effect on the performance of the gasket 1000. A gasket that is too soft will compress too readily, and provide a poor seal. A gasket that is too hard will crack under pressure. Persons of ordinary skill in the art can generally ascertain an acceptable hardness for a gasket based on the design stresses to which it will be subject. For example, embodiments of the gasket 1000 for use in water pipes may have a hardness of about 70-80 durometer when measured by Active Standard ASTM D2240 using Shore A. A specific embodiment of the gasket 1000 has a hardness of about 75 durometer when measured by Active Standard ASTM D2240 using Shore A.

Tensile strength can have an effect on the performance of the gasket 1000. When compressed the gasket 1000 is also stretched, and a gasket without sufficient tensile strength can fail under such compression. Persons of ordinary skill in the art can generally ascertain an acceptable tensile strength for a gasket based on the design stresses to which it will be subject. For example, embodiments of the gasket 1000 for use in water pipes may have a tensile strength of at least about 1500 psi (10.34 MPa) when measured by Active Standard ASTM D412. Further embodiments may have a tensile strength of at least about 2000 psi (13.79 MPa) when measured by Active Standard ASTM D412.

Likewise, the elongation of the elastomeric material can affect the gasket's performance. Some embodiments of the elastomer have an elongation of at least about 150% when measured by Active Standard ASTM D412. Further embodiments have an elongation of at least about a value selected from: 200%, 250%, and 300% when measured by Active Standard ASTM D412.

In a specific embodiment, the gasket 1000 is constructed of styrene-butadiene rubber (SBR). In further embodiments the SBR may have one or more of the following properties: a hardness of about 70-80 durometer when measured by Active Standard ASTM D2240 using Shore A, a compression set no greater than about 20% when measured by Active Standard ASTM D395 Method B, a tensile strength of at least about 1500 psi (10.34 MPa) when measured by Active Standard ASTM D412, and an elongation of at least about 150% when measured by Active Standard ASTM D412. In a more specific embodiment of the gasket 1000, the SBR has all of the foregoing properties.

### C. PIPE JOINT

A pipe joint 2000 is provided containing the gasket 1000 disclosed above. In a general embodiment, the pipe joint 2000 comprises: a first pipe 2100 having a first inner diameter (h) and comprising a first threaded end 2110; a first threaded pipe flange 2120 having a first outer diameter (f), screwed onto the first threaded end 2110, forming a first flange/pipe interface 2130 having a first interfacial diameter (k); a second flange 2200 having a second outer diameter (g); any of the circular gaskets 1000 disclosed above between the first and second pipe flanges 2120 & 2200, and positioned to contact the inner region 1200 of the gasket 1000 with the first flange/pipe interface 2130. The second pipe flange may be any known in the art. Some embodiments of the second flange 2200 are selected from the group consisting of: a pipe flange, a blind flange, and a flange on an appurtenance.

In some embodiments of the joint 2000 both flanges are threaded. In such embodiments, the joint 2000 comprises a second pipe 2300 with a second threaded end 2310 on which the second (threaded) pipe flange is screwed, forming a second flange/pipe interface 2330 having a second interfacial diameter (l); the second pipe 2300 having a second inner diameter (i). In such embodiments the gasket 1000 is positioned to contact the inner region 1200 of the gasket 1000 with the first flange/pipe interface 2130 and with the second flange/pipe interface 2330. This can be accomplished even if the two flange/pipe interfaces are offset, due to the relative dimensions of the gasket's outer and inner regions 1200 & 1300. In some embodiments of the joint 2000 the interfaces are offset; in such embodiments the first flange/pipe interface 2130 is not concentric with the second flange/pipe interface 2330. In further embodiments of the joint 2000 the center of the first flange/pipe interface 2130 and the center of the second flange/pipe interface 2330 are offset by an offset distance that is less than the first radial length (b) of the inner region 1200 of the gasket 1000. In some embodiments of the joint 2000, the inner region 1200 of the gasket 1000 has a radial length of at least 25% of the difference between the first interfacial diameter (k) and the first outer diameter (f). In further embodiments the gasket 1000 has a radial length at least 33% of the difference between the first interfacial diameter (k) and the first outer diameter (f).

The ends of the pipes may be tapered to accommodate the threaded flanges. In various embodiments of the joint 2000, the first threaded end 2110 is tapered, the second threaded end 2310 is tapered, or both.

Typically the first and second outer diameters (f) & (g) of the pipe flanges will be about the same, and the gasket 1000 will have a third outer diameter (j) that is no greater than either of the first or second outer diameters (f) & (g). Frequently when the first and second inner diameters (h) & (i) of the pipes are approximately the same, the first diameter (a) of the central opening 1100 of the gasket 1000 will be smaller than either of the first and second inner diameters (h) & (i). In such embodiments the gasket 1000 will extend at least slightly into the portion of the joint 2000 that contains the fluid.

The joint 2000 may further comprise means to accommodate fasteners. Such embodiments of the joint 2000 may comprise a plurality of fasteners 2500 fastening the first flange 2120 to the second flange 2200. Some embodiments of the joint 2000 comprise: a first plurality of fastener openings 2122 in the first flange 2120; a second plurality of fastener openings 2322 in the second flange 2200; a third plurality of fastener openings 1310 in the outer region 1300 of the gasket 1000; and a plurality of fasteners 2500 fastening the first flange 2120 to the second flange 2200, each of said plurality of fasteners 2500 positioned in one of said first plurality of fastener openings 2122, one of said second plurality of fastener openings 2322, and one of said third plurality of fastener openings 1310. The fasteners may be any suitable fasteners known in the art. In a specific embodiment the fastener is a bolt, optionally secured with a nut. The strength and size of the fastener can be designed as needed. In a specific embodiment of the joint 2000 the bolts 2510 are grade 2 or higher. The fasteners may be tightened enough to exert sufficient pressure on the gasket 1000 to provide a good seal, not so much as to risk failure of the flange or cracking the gasket 1000. In some embodiments of the joint 2000 the fasteners are tightened to about 90-650 ft lb (122-881 N m) of torque. In further embodiments of the joint 2000 the fasteners are tightened to about 120-650 ft lb (163-881 N m) of torque. In a specific embodiment of the joint 2000 the fasteners are tightened to about 200 ft lb (271 N m) of torque. Such torques are particularly suitable for iron joints carrying water at typical pressures.

In a particular embodiment of the joint 2000, the pipe joint 2000 is an iron joint in a water or wastewater system. In such embodiments the first pipe 2100, first flange 2120, and second flange 2200 may each be independently constructed of a material selected from ductile iron or gray iron. The joint 2000 in such applications will often be under internal pressures selected from the group consisting of: at least about 200 psi (1.38 MPa), at least about 250 psi (1.72 MPa), and at least about 350 psi (2.41 MPa). In some such embodiments the pipes, flanges, or both will be of standardized dimensions and construction. For example, the first and second pipes 2100 & 2300 may both be constructed from ductile iron, and the first and second pipes 2100 & 2300 may have about the same nominal pipe size, nominal thickness, and outer diameter that is selected from Table 1 of ANSI/AWWA C115/A21.15-11 (which is incorporated by reference herein as necessary to adequately describe any such claimed embodiments). In such embodiments the first and second flanges 2120 & 2200 may both be constructed from ductile iron or gray iron, and the first and second flanges 2120 & 2200 may have about the same nominal pipe size, outer diameter, and axial thickness that is selected from Table 2 of ANSI/AWWA C115/A21.15-11 (which is incorporated by reference herein as necessary to adequately describe any such claimed embodiments).

### D. WORKING EXAMPLE

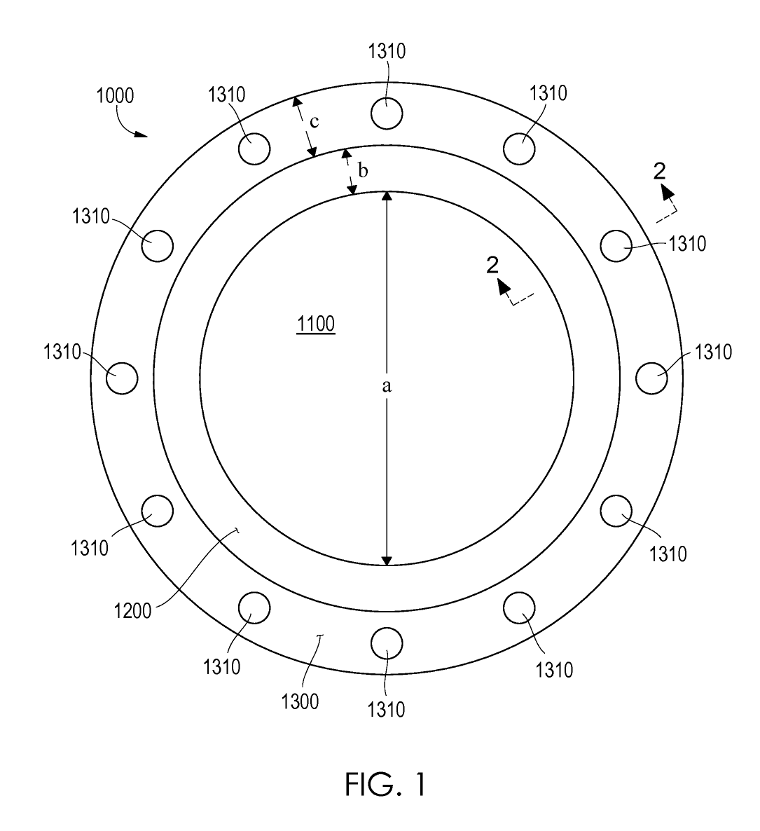

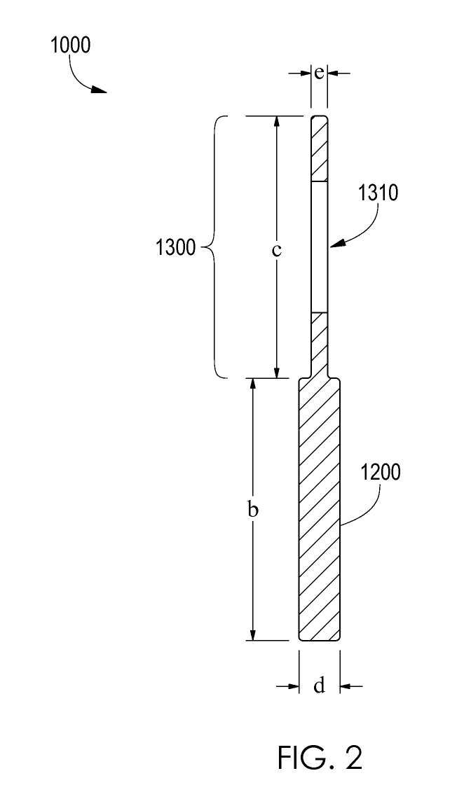

Specific embodiments of the gasket 1000 and the joint 2000 are provided by way of non-limiting example. The exemplary embodiment of the gasket 1000 is shown in FIGS. 1 and 2. The gasket 1000 has inner and outer regions 1200 & 1300, each of which are shaped like rectangular toroids of different dimensions. The gasket 1000 is constructed of SBR having a hardness of about 75 durometer when measured by Active Standard ASTM D2240 using Shore A, a compression set no greater than about 20% when measured by Active Standard ASTM D395 Method B, a tensile strength of at least about 1500 psi (10.34 MPa) when measured by Active Standard ASTM D412, and an elongation of at least about 150% when measured by Active Standard ASTM D412. Referring to FIG. 1, the diameter of the central opening 1100 (first diameter) is shown as a, and in the exemplary embodiment is 24″ (61 cm). The outer diameter of the gasket 1000 (third outer diameter (j)) is 32″ (81.3 cm), shown as j. The inner region 1200 has a radial length (first radial length (b)) shown as b, which is 1⅜″ (3.5 cm). The outer region 1300 has a second radial length (c) of 2⅝″ (6.7 cm). The exemplary gasket 1000 comprises 20 bolt holes each 1⅜″ (3.5 cm) diameter, to accommodate 1¼″ (3.2 cm) diameter bolts 2510. The center of each bolt hole is 26¾″ (67.9 cm) from the center of the gasket 1000.

Referring to FIG. 2, the axial thickness of the inner region 1200 (first axial thickness (d)) is shown as d, which is ⅜″ (9.5 mm); and the axial thickness of the outer region 1300 (second axial thickness) is shown as e, which is ⅛″ (3.2 mm). These dimensions are sufficient to provide a seal in a pipe joint 2000 when the bolts 2510 are tightened to about 90-650 ft lb (122-881 N m) of torque.

These dimensions are suitable for use with a ductile iron flange that conforms to Section 4.3 of ANSI/AWWA C115/A21.15-11, Tables 2 and 3, having an outer diameter of 32″ (81.3 cm), which are incorporated herein by reference to the extent necessary to adequately describe anything claimed.

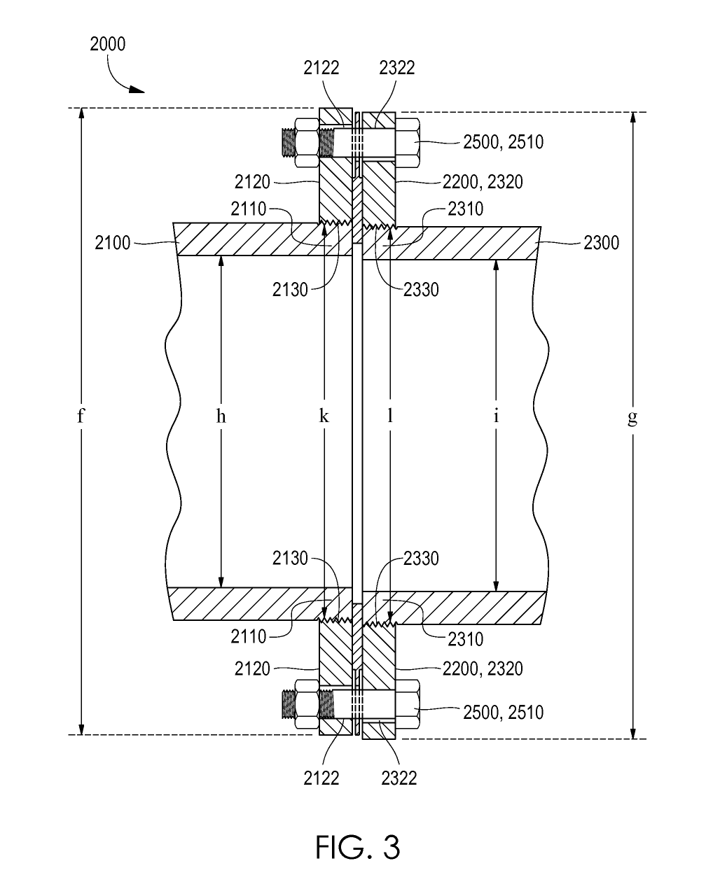

The exemplary embodiment of the joint 2000 is shown in FIG. 3, comprising two pipes each screwed into threaded pipe flanges. Both pipes terminate in threaded flanges, and all of the components are ductile iron. Both the first and second pipe 2100 & 2300 are nominal pipe sized 24″ (61.0 cm) with nominal thicknesses of 0.47″ (1.2 cm) (shown as f for the first pipe 2100). The outer diameter of each, shown as g for the first pipe 2100, is 25.8″ (65.5 cm).

Each of the threaded flanges has an outer diameter (first and second outer diameters (f) & (g), respectively) of 32″ (81.3 cm) (shown as h for the first flange 2120) and 20 bolt holes having centers 29½″ (74.3 cm) from the center of the flange.

The joint 2000 when assembled is suitable for use with fluids at pressures up to 250 psi (1.72 MPa) under normal conditions. Note that in practice the two flange/pipe interfaces were offset by approximately ¼″ (7 mm), such that both interfaces contacted the inner region 1200 of the gasket 1000. When tested, the joint 2000 maintained a good seal for about 10 minutes when pressurized up to 750 psi (5.17 MPa). Twenty unmarked (probably grade 2) bolts 2510 were used to fasten the first flange 2120 to the second flange 2200 and the gasket 1000 at about 90 ft lb (122 N m) torque. This joint 2000 is suitable for use in potable water systems, among other applications.

### E. CONCLUSIONS

It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

The foregoing description illustrates and describes the processes, machines, manufactures, compositions of matter, and other teachings of the present disclosure. Additionally, the disclosure shows and describes only certain embodiments of the processes, machines, manufactures, compositions of matter, and other teachings disclosed, but, as mentioned above, it is to be understood that the teachings of the present disclosure are capable of use in various other combinations, modifications, and environments and are capable of changes or modifications within the scope of the teachings as expressed herein, commensurate with the skill and/or knowledge of a person having ordinary skill in the relevant art. The embodiments described hereinabove are further intended to explain certain best modes known of practicing the processes, machines, manufactures, compositions of matter, and other teachings of the present disclosure and to enable others skilled in the art to utilize the teachings of the present disclosure in such, or other, embodiments and with the various modifications required by the particular applications or uses. Accordingly, the processes, machines, manufactures, compositions of matter, and other teachings of the present disclosure are not intended to limit the exact embodiments and examples disclosed herein. Any section headings herein are provided only for consistency with the suggestions of 37 C.F.R. §1.77 or otherwise to provide organizational queues. These headings shall not limit or characterize anything claimed.

What is claimed:

1. A circular gasket for use in sealing a joint between two pipe flanges, the gasket comprising:
(a) a central opening having a first diameter;
(b) an inner region adjacent to the central opening, the inner region having an approximately constant first axial thickness and a first radial length;
(c) an outer region adjacent to the inner region, the outer region having a second axial thickness and a second radial length, the second axial thickness being less than the first axial thickness, and the second radial length being no more than about thrice the first radial length;
and wherein the gasket is constructed from an elastomeric material.

2. The gasket of claim 1, in which the first axial thickness is constant within about 25%.

3. The gasket of claim 1, in which the second axial thickness is constant.

4. The gasket of claim 1, in which the second radial length is no more than about twice the first radial length.

5. The gasket of claim 1, in which the inner region is a rectangular toroid.

6. The gasket of claim 1, in which the inner region is a rectangular toroid, and in which the outer region is a rectangular toroid.

7. The gasket of claim 1, in which the inner region comprises two opposite faces in the axial direction, and in which the two opposite faces are substantially flat and parallel to one another.

8. The gasket of claim 1, the outer region comprising a plurality of openings positioned to accommodate a plurality of fasteners.

9. The gasket of claim 1, wherein the gasket is constructed of styrene-butadiene rubber (SBR).

10. The gasket of claim 1, wherein the gasket is constructed of styrene-butadiene rubber (SBR) having a hardness of about 70-80 durometer when measured by Active Standard ASTM D2240 using Shore A.

11. The gasket of claim 1, wherein the gasket is constructed of styrene-butadiene rubber (SBR) having a hardness of about 75 durometer when measured by Active Standard ASTM D2240 using Shore A.

12. The gasket of claim 1, wherein the gasket is constructed from a low compression set elastomeric material.

13. The gasket of claim 1, wherein the gasket is constructed from an elastomeric material with a compression set no greater than about 20% when measured by Active Standard ASTM D395 Method B.

14. The gasket of claim 1, wherein the gasket is constructed from an elastomeric material with a tensile strength of at least about 1500 psi (10.34 MPa) when measured by Active Standard ASTM D412.

15. The gasket of claim 1, wherein the gasket is constructed from an elastomeric material with a tensile strength of at least about 2000 psi (13.79 MPa) when measured by Active Standard ASTM D412.

16. The gasket of claim 1, wherein the gasket is constructed from an elastomeric material with an elongation of at least about 150% when measured by Active Standard ASTM D412.

17. The gasket of claim 1, wherein the gasket is constructed from an elastomeric material with an elongation of at least about 300% when measured by Active Standard ASTM D412.

18. The gasket of claim 1, wherein the gasket is constructed of styrene-butadiene rubber (SBR) having a hardness of about 70-80 durometer when measured by Active Standard ASTM D2240 using Shore A, a compression set no greater than about 20% when measured by Active Standard ASTM D395 Method B, a tensile strength of at least about 1500 psi (10.34 MPa) when measured by Active Standard ASTM D412, and an elongation of at least about 150% when measured by Active Standard ASTM D412.

19. A pipe joint comprising:
(a) a first pipe having a first inner diameter, comprising a first threaded end;
(b) a first threaded pipe flange having a first outer diameter, screwed onto the first threaded end, forming a first flange/pipe interface having a first interfacial diameter;
(c) a second flange having a second outer diameter;
(d) the circular gasket of claim 1 between the first and second pipe flanges, and positioned to contact the inner region of the gasket with the first flange/pipe interface.

20. The joint of claim 19, in which the second flange is a second threaded pipe flange, and comprising a second pipe with a second threaded end on which the second pipe flange is screwed, forming a second flange/pipe interface having a second interfacial diameter (l); the second pipe having a second inner diameter (i); and in which the gasket is positioned to contact the inner region of the gasket with the first flange/pipe interface and with the second flange/pipe interface.

21. The joint of claim 20, in which the first and second outer diameters of the pipe flanges are about the same, and in which the gasket has a third outer diameter that is no greater than either of the first or second outer diameters.

22. The joint of claim 20, in which first and second inner diameters of the pipes are approximately the same, and in which the first diameter of the central opening of the gasket is smaller than either of the first and second inner diameters.

23. The joint of claim 19, comprising:
(e) a first plurality of fastener openings in the first flange;
(f) a second plurality of fastener openings in the second flange;
(g) a third plurality of fastener openings in the outer region of the gasket; and
(h) a plurality of fasteners fastening the first flange to the second flange, each of said plurality of fasteners positioned in one of said first plurality of fastener openings, one of said second plurality of fastener openings, and one of said third plurality of fastener openings.

24. The joint of claim 19, in which the first pipe, first flange, and second flange are each independently constructed of a material selected from ductile iron or gray iron.

25. The joint of claim 19, containing a carried fluid, in which the carried fluid exerts a pressure on the joint selected from the group consisting of: at least about 200 psi (1.38 MPa), at least about 250 psi (1.72 MPa), and at least about 350 psi (2.41 MPa).

26. The joint of claim 20, in which the first flange/pipe interface is not concentric with the second flange/pipe interface.

27. The joint of claim 20, in which the first and second pipes are both constructed from ductile iron, and in which the first and second pipes are capable of operating with an internal pressure of 250 psi (1.72 MPa).

28. The joint of claim 20, in which the first and second pipes are both constructed from ductile iron, and in which both of the first and second pipes have about the same nominal pipe size, nominal thickness, and outer diameter that is selected from Table 1 of ANSI/AWWA C115/A21.15-11.

29. The joint of claim 19, in which the first and second flanges are both constructed from ductile iron or gray iron, and in which the first and second flanges have about the same nominal pipe size, outer diameter, and axial thickness that is selected from Table 2 of ANSI/AWWA C115/A21.15-11.

30. The joint of claim 19, in which the first threaded end is tapered.

31. The joint of claim 19, comprising a plurality of fasteners fastening the first flange to the second flange.

32. The joint of claim 19, comprising a plurality of bolts fastening the first flange to the second flange.

33. The joint of claim 19, comprising a plurality of bolts of grade 2 or higher fastening the first flange to the second flange.

34. The joint of claim 19, comprising a plurality of bolts fastening the first flange to the second flange, the bolts tightened to about 120-650 ft lb (163-881 N m) of torque.

35. The joint of claim 19, comprising a plurality of bolts fastening the first flange to the second flange, the bolts tightened to about 200 ft lb (271 N m) of torque.

36. The joint of claim 19, in which the inner region of the gasket has a radial length of at least 25% of the difference between the first interfacial diameter and the first outer diameter.

37. The joint of claim 20, in which in which the center of the first flange/pipe interface and the center of the second flange/pipe interface are offset by an offset distance that is less than the first radial length of the inner region of the gasket.

38. The joint of claim 19, in which the second flange is selected from the group consisting of: a pipe flange, a blind flange, and a flange on an appurtenance.
